(19) United States
(12) Patent Application Publication
(10) Pub. No.: US 2014/0289032 A1
(43) Pub. Date: Sep. 25, 2014

(54) Multi-User Reward Integration System and Methods of Use Thereof

(71) Applicants: M. Christopher Muto, Wayland, MA (US); Joseph D. Tagliente, Weston, MA (US); Joseph M. Tagliente, Weston, MA (US)

(72) Inventors: M. Christopher Muto, Wayland, MA (US); Joseph D. Tagliente, Weston, MA (US); Joseph M. Tagliente, Weston, MA (US)

(73) Assignee: GOPINION, INC., Weston, MA (US)

(21) Appl. No.: 14/221,231

(22) Filed: Mar. 20, 2014

Related U.S. Application Data
(60) Provisional application No. 61/803,692, filed on Mar. 20, 2013.

(51) Int. Cl. G06Q 30/02

(52) U.S. Cl. CPC G06Q 30/0217
USPC 705/14.19

(57) ABSTRACT

The present invention provides reward systems and methods that offer significant enhancement to increasing consumer interest and/or to increase consumer engagement with a participating business. In particular, the present invention provides software applications that utilize the methods described herein to offer a plurality of rewards to a consumer using a Multi-User Reward Integration (MURI) system.

### RELATED APPLICATIONS

This application is a U.S. Utility Application that claims the benefit of priority from U.S. Provisional Patent Application No. 61/803,692, filed on Mar. 20, 2013, the entirety of which is incorporated herein by reference.

### BACKGROUND OF THE INVENTION

Reward programs have been used in commerce to alter behavior and produce greater interest in business. Even in the world of e-commerce, reward systems have been used to offer rewards to consumers of goods and services over the internet or mobile devices. Whether the commercial event is the purchase of goods or services, or the act of taking a survey, the selection of the type of rewards offered in a reward system can be a critical driver in the success of the commercial activity.

With respect to surveys, where the consumer has not engaged in a purchase event, there is little motivation to complete the transaction beyond the reward system that may be in place. As such, the reward system might be the only driver of consumer compliance in completing these surveys. To this point, it is well known that consumer feedback is critical for product and service industries. Such information is often primarily obtained using surveys. And without consumer compliance in completing these surveys, the data obtained from such sources offers very little significance; and is of very little use in any root cause analysis of negative consumer feedback.

Even with the convenience of e-commerce, generating business or increased consumer compliance in completing surveys through the use of existing reward systems based on sweepstakes, instant win, or coupon principles, falls far shorter than desired by the participating business. Accordingly, there is a need to find new reward systems useful for increasing consumer interest and/or to increase consumer engagement with a participating business, e.g., as with surveys (e.g., affording greater significance to data obtained from these surveys).

### SUMMARY OF THE INVENTION

The present invention provides reward systems and methods that offer significant enhancement to increasing consumer interest and/or to increase consumer engagement with a participating business, e.g., in consumer compliance in completing surveys that afford statistically significant/accurate measurements of consumer feedback. In particular, the present invention provides software applications that utilize the methods described herein to offer a plurality of rewards to a consumer using a Multi-User Reward Integration (MURI) system.

Accordingly, in one aspect the invention provides a method of offering a plurality of rewards to a consumer. The method comprises the steps of initiation of an interface by a consumer of goods or services of a first user on a network; completion of a transaction on the network by the consumer of the goods or services; presentation on the network of a first user-affiliated reward to the consumer using a Multi-User Reward Integration (MURI) system, wherein the MURI system presents the first user-affiliated reward in combination with one or more secondary user-affiliated rewards from users that are not said first user, such that a plurality of rewards is offered to the consumer.

In another aspect, the invention provides a Multi-User Reward Integration (MURI) system comprising a machine readable medium having instructions stored thereon for execution by a processor to perform a method of offering a plurality of rewards to a consumer. The method comprises the steps of initiation of an interface by a consumer of goods or services of a first user on a network; completion of a transaction on the network by the consumer of the goods or services; presentation on the network of a first user-affiliated reward to the consumer using a Multi-User Reward Integration (MURI) system, wherein the MURI system presents the first user-affiliated reward in combination with one or more secondary user-affiliated rewards from users that are not said first user, such that a plurality of rewards is offered to the consumer.

Another aspect of the invention provides a method of advertising goods or services by offering a consumer a user-affiliated reward. The method comprises the steps of initiation of an interface by a consumer of goods or services of a first user on a network; completion of a transaction on the network by the consumer of the goods or services; presentation on the network of a first user-affiliated reward to the consumer using a Multi-User Reward Integration (MURI) system, wherein the MURI system presents the first user-affiliated reward in combination with one or more secondary user-affiliated rewards from users that are not said first user, such that the presentation of the first user-affiliated reward or the secondary user-affiliated rewards serves to advertise the presented rewards offered to the consumer.

In yet another aspect, the invention provides a method of offering a plurality of rewards to a consumer engaged in a non-purchase event. The method comprises the steps of initiation of an interface by a consumer of goods or services of a first user on a network; completion of a non-purchase event on the network by the consumer of the goods or services; presentation on the network of a first user-affiliated reward to the consumer using a Multi-User Reward Integration (MURI) system, wherein the MURI system presents the first user-affiliated reward in combination with one or more secondary user-affiliated rewards from users that are not said first user, such that a plurality of rewards is offered to the consumer.

### BRIEF DESCRIPTION OF DRAWINGS

FIG. 1 depicts the flow diagram of the consumer feedback loop.

FIG. 2 depicts an example of a graphic user interface (GUI) offering a coupon, and displaying the time remaining for use

FIG. 3 depicts an example of a graphic user interface (GUI) of a Home Page for the user.

FIG. 4 depicts an example of a graphic user interface (GUI) and process flow for the survey stream in the web app.

FIG. 5 depicts an example of a graphic user interface (GUI) of a page for storing and managing pending gopinions.

FIG. 6 depicts an example of a graphic user interface (GUI) of a page for storing and managing rewards.

FIG. 7A depicts an example of a sample graphic user interface (GUI) of a Dashboard page. FIG. 7B is a screen capture of a graphic user interface (GUI) of a Dashboard page.

FIG. 8 is a screen capture of a graphic user interface (GUI) of the “Office Manager,” a box on the dashboard that allows the user to set their discount rates for each of the levels of user at their establishment.

### DETAILED DESCRIPTION OF THE INVENTION

The present invention provides tools and methods that offer novel reward systems in response to a completed transaction or event, e.g., a non-purchase event such as a donation or completing a survey, that produce enhancement in consumer engagement (e.g., compliance in completing surveys, and afford statistically significant/accurate measurements of consumer feedback, e.g., constructive feedback). In particular, in contrast to existing systems wherein rewards are focused on a single business, or user, the present invention provides software applications, e.g., mobile applications that utilize the methods described herein to offer and administer rewards to consumers using Multi-User Reward Integration (MURI) upon completion of the transaction. Such tools and methods may also comprise the administration of surveys associated with the MURI system as the completed transaction, e.g., non-purchase event, eliciting statistically significant feedback to effect global positive commercial change.

The present invention, including novel systems, methods, applications, and related software will be described with reference to the following definitions that, for convenience, are set forth below. Unless otherwise specified, the below terms used herein are defined as follows:

### I. DEFINITIONS

As used herein, the term “a,” “an,” “the” and similar terms used in the context of the present invention (especially in the context of the claims) are to be construed to cover both the singular and plural unless otherwise indicated herein or clearly contradicted by the context.

The term “consumer” is used herein to describes a person or entity that engages (e.g., purchases, obtains, or receives) goods or services for direct use or evaluation, i.e., as opposed for resale or use in production and manufacturing. It is the consumer, with respect to the present invention, that is presented the rewards in the reward systems of the present invention. As described herein, the term “consumers” includes all potential consumers as well as actual consumers, and those that would also serve as a marketing base (or polling source) to assist in marketing goods or services, e.g., post consumption consumers or pre-consumption consumers.

The language “consumer compliance,” as used herein describes the measure of a consumer presented with a survey to take and complete the survey. Accordingly, a consumer who takes and completes a survey presented to him/her has demonstrated consumer compliance. Moreover, certain methods, tools, and software of the present invention, e.g., that utilize reward systems presented herein, provide an increase in overall consumer compliance.

The term “constructive” as used herein in the expression, “constructive consumer feedback describes feedback that may be used to assist in suggestion of positive change, e.g., commercial or noncommercial. In one embodiment, this constructive feedback may be negative, e.g., provide information related to a negative experience, such that a suggestion of avoiding actions taken during this negative experience could inform of a way to create a global positive commercial change. In another embodiment, this constructive feedback may be positive, e.g., provide information related to a positive experience, such that a suggestion of performing actions taken during this positive experience could inform of a way to create a global positive commercial change.

The term “feedback” is art-recognized, and describes the sentiment or opinion from a consumer based on experience with goods (e.g., a product) or service of a user.

The language “goods or services” is used herein to describe the continuum of pure service at one endpoint and pure commodity goods at the other endpoint. In particular consumers of the present invention may consume a physical item or a good, an intangible service, or a combination of thereof. In general, goods are items that can be seen and touched, and services are provided by other people. In certain embodiments, a service includes professional services rendered to an individual. In certain embodiments, a service includes any service rendered to a group of two or more people (e.g., a locality), such as political service.

The term “indicating” describes the act of selecting, or “clicking” a displayed option in the graphic interface, for example, by touching the positive or negative response “button” with your finger on a touch sensitive screen (e.g., tapping or directionally sliding/swiping) or on a monitor with a pointing device used to actuate a feature using a button at the on-screen location of the pointer (e.g., a mouse pointer, often shown as an arrow).

The term “interfacing” as used herein, for example in the expression “interfacing with a user,” describes the means of communication between two entities, for example the user and a network. In certain embodiments, the interfacing may be bi-directional. In other embodiments, the interfacing may be uni-directional. In particular embodiments, such interfacing may include receiving, confirming, rejecting, suggesting, proposing and/or assigning profile information.

The language “machine-readable medium” is art-recognized, and describes a medium capable of storing data in a format readable by a mechanical device (rather than by a human). Examples of machine-readable media include magnetic media such as magnetic disks, cards, tapes, and drums, punched cards and paper tapes, optical disks, barcodes, magnetic ink characters, and solid state devices such as flash-based, SSD, etc. Common machine-readable technologies include magnetic recording, processing waveforms, and barcodes. In particular embodiments, the machine-readable device is a solid state device. Optical character recognition (OCR) can be used to enable machines to read information available to humans. Any information retrievable by any form of energy can be machine-readable. Moreover, any data stored on a machine-readable medium may be transferred by streaming over a network.

The term “Micro-Survey” describes binary surveys as described in U.S. Provisional Application No. 61/803,676 titled “Enhancement of Root Cause Analysis of Consumer Feedback Using Micro-Surveys and Applications Thereof” filed on Mar. 20, 2013, the entirety of which is incorporated herein by reference thereto; and are intended to be completed by the ordinary consumer within one minute after the survey is administered. Such surveys are intended to increase consumer compliance to improve the statistical significance of data obtained from a given survey, and as such afford a greater ability to determine the root cause of negative consumer feedback. Micro-Surveys, in certain embodiments, are administered via a mobile device, e.g., a mobile application, or via a computer, e.g., the internet. In one embodiment, a Micro-Survey comprises a unified question stream (UQS) to determine a root cause of negative consumer feedback with an initial set of 1 to 5 binary questions in root cause analysis format, optionally followed by a secondary set of 1 to 5, e.g., 1 to 3, e.g., 1 or 2 binary questions, in root cause format dynamically selected based upon identification of negative feedback for one of the answers by the consumer to said initial set of questions. In certain embodiments, the answers to these binary questions are either a positive indicator mark, for example a checkmark or a plus sign, or a negative indicator mark, for example an X sign or a minus sign and are answered by clicking, tapping, or directionally sliding/swiping said indicator.

The language “Multi-User Reward Integration System” is described herein below, and generally describes the system wherein rewards from a first user are presented in combination with one or more secondary user-affiliated rewards. This system is in contrast to the art-recognized reward systems wherein the reward presented is directed solely to a single user, such as sweepstakes where the consumer enters for a chance to win a specific reward from a user, instant win games where the consumer plays a game for a chance to win a specific reward from a user, or use of a simple coupon directed to use at a specific user.

The language “non-purchase event” is used herein to describe commercial or noncommercial transactions that do not comprise a purchase as a definite subsequent step. Such non-purchase events may include taking surveys, e.g., Micro-Surveys, either pre or post consumption, or donation to a charity, or even checking-in socially to a location. In certain embodiments, the non-purchase event is not followed by a purchase.

The term “offering” is art-recognized, and used herein to describe the act of making available given a certain set of conditions or steps, such as in the expression “offering a plurality of rewards to a consumer.”

The language “purchase event” is used herein to describe commercial transactions that do comprise a purchase as a definite subsequent step, affording different motivations for completion than a non-purchase event. Such purchase events may be made in exchange for the promised reward.

The term “reward” is used herein to describe an item or offer provided in exchange for the completion of a transaction, e.g., a non-purchase event, described herein. Such rewards are selected from, but not limited to promotional items, coupons, rebates, discounts, and special offerings on goods and/or services. In certain embodiments, the reward may be based on the extent of consumer engagement, e.g., how many surveys, e.g., Micro-Surveys, a consumer has completed, e.g., over a designated period of time.

The language “root cause analysis” describes a method of problem solving that tries to identify the root causes of faults or problems that cause operating events. Root cause analysis attempts to solve problems by attempting to identify and correct the root causes of events, as opposed to simply addressing their symptoms. By focusing correction on root causes, problem recurrence can be prevented or reduced.

The language “secondary users,” as used herein, describes any user that is not the first user. For example, the second, third, fourth, fifth, tenth, or 100^{th} user are all secondary users with particular respect to the first user. In addition, in certain embodiments, the secondary user may be the network operator, e.g., that may offer rewards separate from a user that is a service provider or provider of goods.

The term “storing” means on storing on a network, or an array of networks, e.g., which are operably coupled to interact through a given interface.

The term “transaction” as used herein, includes both purchase and non-purchase events described herein.

The language “unified question stream” or “UQS,” which are used interchangeably herein to describe the question format for a series of questions in a survey that follow a particular information stream to determine the root cause of a particular problem. Moreover, in such a question stream, if a consumer does not identify an aspect of their experience as having a problem, it can be concluded that the Member was generally satisfied with that aspect of their experience. In contrast, other survey formats will ask for a consumer's general impression of every aspect of a product or experience.

The term “user” is used herein to describe any entity that desires to analyze consumer sentiment and interacts with the methods, tools, and applications of the present invention for that purpose. In certain embodiments, such users may include service providers. In certain embodiments, such users may include a provider of goods.

The language “user-affiliated reward” describes the rewards of the systems and methods presented herein attributable to a designated user, for example, in the language “first user-affiliated reward” for a reward that is provided by a first user; as compared with a “secondary user-affiliated reward” that is a reward that provided by a secondary user, i.e., a user that is not the first user. The administered user-affiliated reward may be used or placed on a network.

### II. MULTI-USER REWARD INTEGRATION SYSTEM OF THE INVENTION

In one embodiment of the present invention is a consumer reward and merchant advertising system offered, for example, by mobile or web application. The system gives the consumer a reward (e.g., a discount, deal, or free coupon) each time an event, e.g., a non-purchase event occurs is completed (e.g., completing a survey) and submitted. The reward system allows the business merchant, or user, to choose whether or not they would present a reward to the consumer that completes a transaction/event. When the merchant chooses to present a reward(s) to the customer that completes an event, they are able to create a specific reward of their choosing that is distributed through the reward(s) system as a featured discount in combination with rewards of other merchant/users, i.e., such reward is presented along with rewards from secondary users. However, if the business, or user chooses not to present rewards to the consumer that completes an action, the featured discount area may be used to promote and offer deals from other businesses, or secondary users alone who would enroll, e.g., offer payment, to make their offers available to the consumers. The system allows the consumer to select the featured deal from a first user or to browse a “rewards store” which presents all the discounts that all user merchants, i.e., secondary users, are offering through their places of business. Moreover, if, for example, the consumer selects a reward from the “rewards store” the deal may be instant and may be used immediately, e.g., through a mobile or web coupon.

As such, the present invention provides methods directed to offering rewards to a consumer, advertising, and methods of doing business utilizing the Multi-User Reward Integration (MURI) of the present invention.

Accordingly, in one embodiment, the invention provides a Multi-User Reward Integration (MURI) system comprising a machine readable medium having instructions stored thereon for execution by a processor to perform a method of offering a plurality of rewards to a consumer comprising the steps of
initiation of an interface by a consumer of goods or services of a first user on a network;
completion of a transaction on the network by the consumer of the goods or services;
presentation on the network of a first user-affiliated reward to the consumer using a Multi-User Reward Integration (MURI) system, wherein the MURI system presents the first user-affiliated reward in combination with one or more secondary user-affiliated rewards from users that are not said first user, such that a plurality of rewards is offered to the consumer.

Moreover, the instructions stored on the machine-readable medium may be implemented by online software or offline software. In certain embodiments, the instructions stored on the machine-readable medium are online software. In certain embodiments, the software is an online application, e.g., a web-based application or a cloud-based application. In certain embodiments, the software is an offline application, e.g., Software as a Service (SaaS). For example, desktop software may interact directly with internet server (e.g., without the need for a browser such as the world wide web)

In certain embodiments of the Multi-User Reward Integration (MURI) system, the instructions stored on the machine-readable medium are mobile application software.

In certain embodiments of the Multi-User Reward Integration (MURI) system, the instructions stored on the machine-readable medium are online software. In particular embodiments, the software is an online application, e.g., wherein the software is a web-based application or a cloud-based application.

In certain embodiments of the Multi-User Reward Integration (MURI) system, the machine-readable media described herein may be selected from the group consisting of magnetic media, punched cards, paper tapes, optical disks, barcodes, magnetic ink characters, and solid state devices (e.g., flash-based, SSD, etc.). For example, in a particular embodiment, the machine-readable medium is a solid state device. In certain embodiments, the machine-readable medium is selected from the group consisting of magnetic media, optical disks, and solid state devices.

In certain embodiments of the Multi-User Reward Integration (MURI) system, the network for initiating an interface is different than the network for presenting the rewards.

In certain embodiments of the Multi-User Reward Integration (MURI) system, the method further comprises the step of administration of the user-affiliated reward to the consumer on the network. In one particular embodiment, the first user-affiliated reward is selected by the consumer and administered to the consumer. In another particular embodiment, the secondary user-affiliated reward is selected by the consumer and administered to the consumer.

In certain embodiments of the Multi-User Reward Integration (MURI) system, the method further comprises the step of storage of said user-affiliated reward on the network.

In certain embodiments of the Multi-User Reward Integration (MURI) system, the network for initiating an interface and/or the network for presenting the rewards, is different than the network that stores the rewards

In certain embodiments of the Multi-User Reward Integration (MURI) system, the method further comprises the step of establishment of a consumer profile on the network, wherein said user-affiliated reward is combined with other administered rewards, and stored.

In certain embodiments of the Multi-User Reward Integration (MURI) system, the interfacing by the consumer over a network is accomplished by using the internet over a mobile device.

In certain embodiments of the Multi-User Reward Integration (MURI) system, the interfacing by the consumer over a network is accomplished by using the internet over a computer.

In certain embodiments of the Multi-User Reward Integration (MURI) system, the initiation of the interface by the consumer is accomplished by launching an application on a smartphone or tablet device.

In certain embodiments of the Multi-User Reward Integration (MURI) system, the user-affiliated rewards are selected from the group consisting of promotional items, coupons, rebates, discounts, and special offerings on goods and/or services.

In certain embodiments of the Multi-User Reward Integration (MURI) system, the transaction is a non-purchase event. In particular embodiments, the user-affiliated reward is a discount or a coupon.

In certain embodiments of the Multi-User Reward Integration (MURI) system, the transaction is a purchase event.

In certain embodiments of the Multi-User Reward Integration (MURI) system, the user-affiliated rewards are selected from the group consisting of promotional items, coupons, rebates, discounts, and special offerings on goods and/or services, with the proviso that the transaction is a purchase event when the user-affiliated reward is a promotional item or a special offering.

In certain embodiments of the Multi-User Reward Integration (MURI) system, the first user-affiliated reward is not directed to a good or service similar to the secondary user-affiliated reward.

In certain embodiments of the Multi-User Reward Integration (MURI) system, the step of presentation on the network of a first user-affiliated reward to the consumer comprises the presentation of no reward, such that only the secondary user-affiliated reward(s) is/are presented.

In certain embodiments, rewards may be tiered to establish rewards of greater value being associated with a greater tier. In particular embodiments, achieving greater tiers may be obtained by accruing value related to the earned rewards, which, for example, may be managed using a point system established by exchanging one or more rewards for a given amount of accruable value, i.e., points. Additionally, certain point values may be associated with rewards offered by a secondary user (i.e., a secondary user-affiliated reward), e.g., the network operator.

### III. METHODS OF THE INVENTION

In another embodiment of the invention provides a method of offering a plurality of rewards to a consumer comprising the steps of
initiation of an interface by a consumer of goods or services of a first user on a network;
completion of a transaction on the network by the consumer of the goods or services;
presentation on the network of a first user-affiliated reward to the consumer using a Multi-User Reward Integration (MURI) system, wherein the MURI system presents the first user-affiliated reward in combination with one or more secondary user-affiliated rewards from users that are not said first user,

such that a plurality of rewards is offered to the consumer.

In an additional embodiment, the invention provides a method of advertising goods or services by offering a consumer a user-affiliated reward comprising the steps of
initiation of an interface by a consumer of goods or services of a first user on a network;
completion of a transaction on the network by the consumer of the goods or services;
presentation on the network of a first user-affiliated reward to the consumer using a Multi-User Reward Integration (MURI) system, wherein the MURI system presents the first user-affiliated reward in combination with one or more secondary user-affiliated rewards from users that are not said first user,

such that the presentation of the first user-affiliated reward or the secondary user-affiliated rewards serves to advertise the presented rewards offered to the consumer.

In yet another embodiment, the invention provides a method of offering a plurality of rewards to a consumer engaged in a non-purchase event comprising the steps of
initiation of an interface by a consumer of goods or services of a first user on a network;
completion of a non-purchase event on the network by the consumer of the goods or services;
presentation on the network of a first user-affiliated reward to the consumer using a Multi-User Reward Integration (MURI) system, wherein the MURI system presents the first user-affiliated reward in combination with one or more secondary user-affiliated rewards from users that are not said first user,

such that a plurality of rewards is offered to the consumer.

In certain embodiments of the invention, the method further comprises the step of administration of the user-affiliated reward to the consumer on the network. In one particular embodiment, the first user-affiliated reward is selected by the consumer and administered to the consumer. In another particular embodiment, the secondary user-affiliated reward is selected by the consumer and administered to the consumer.

In certain embodiments of the invention, the method further comprises the step of storage of said user-affiliated reward on the network.

In certain embodiments of the invention, the network for initiating an interface is different than the network for presenting the rewards.

In certain embodiments of the invention, the network for initiating an interface and/or the network for presenting the rewards, is different than the network that stores the rewards

In certain embodiments of the invention, the method further comprises the step of establishment of a consumer profile on the network, wherein said user-affiliated reward is combined with other administered rewards, and stored.

In certain embodiments of the invention, the interfacing by the consumer over a network is accomplished by using the internet over a mobile device.

In certain embodiments of the invention, the interfacing by the consumer over a network is accomplished by using the internet over a computer.

In certain embodiments of the invention, the initiation of the interface by the consumer is accomplished by launching an application on a smartphone or tablet device.

In certain embodiments of the invention, the user-affiliated rewards are selected from the group consisting of promotional items, coupons, rebates, discounts, and special offerings on goods and/or services.

In certain embodiments of the invention, the transaction is a non-purchase event. In particular embodiments, the user-affiliated reward is a discount or a coupon.

In certain embodiments of the invention, the transaction is a purchase event.

In certain embodiments of the invention, the user-affiliated rewards are selected from the group consisting of promotional items, coupons, rebates, discounts, and special offerings on goods and/or services, with the proviso that the transaction is a purchase event when the user-affiliated reward is a promotional item or a special offering.

In certain embodiments of the invention, the first user-affiliated reward is not directed to a good or service similar to the secondary user-affiliated reward.

In certain embodiments of the invention, the step of presentation on the network of a first user-affiliated reward to the consumer comprises the presentation of no reward, such that only the secondary user-affiliated reward(s) is/are presented.

In certain embodiments of the invention, the initiation of the interface by the consumer is accomplished by launching an application on a smartphone or tablet device, the application requests input of a readable code scan (e.g., QR code) or an alphanumeric code. The readable code scan or alphanumeric code input may also identify the geographic location of the consumer. Alternatively, the GPS in the smartphone may identify the geographic location of the consumer. In certain embodiments, the readable code for scanning is located at the bottom of the consumer receipt, folio or invoice for goods or services of the user.

In one embodiment, the invention provides a method of doing business comprising the steps of implementing any MURI system of present invention; operating the MURI system comprising enrolling user businesses to advertise using the system; and collecting payment from users for said enrollment. Moreover, operating the MURI system may also comprise the MURI system interfacing with one or more consumers. In a particular embodiment, the method further comprises supplying analytical information regarding one or more consumers interfacing with the MURI system

### IV. SURVEYS

In certain embodiments, and by no means intended to be limiting of the reward systems and methods described herein, the event may be a post consumption or a pre-consumption non-purchase event of completing a survey related to the goods or services of a user. In certain embodiments, the surveys are Micro-Surveys as described in U.S. Provisional Application No. 61/803,676, titled “Enhancement of Root Cause Analysis of Consumer Feedback Using Micro-Surveys and Applications Thereof” filed on Mar. 20, 2013, the entire contents of which are incorporated herein by reference thereto.

In certain embodiments of the invention, including the reward systems described herein, the method may also comprise the step of administration of a Micro-Survey to a consumer to obtain answers to the questions of the Micro-Survey (e.g., via mobile device or computer), wherein said Micro-Survey comprises a unified question stream (UQS) to determine a root cause of negative consumer feedback with an initial set of 1 to 5 binary questions in root cause analysis format, followed by a secondary set of 1 to 5, e.g., 1 to 3, e.g., 1 or 2 binary questions, in root cause format dynamically selected based upon identification of negative feedback for one of the answers by the consumer to said initial set of questions, such that consumer compliance is increased, and the root cause analysis is enhanced. In certain embodiments, the enhancement is due to a factor selected from the group consisting of increased consumer participation, increased root cause analysis accuracy, increased statistical significance of root cause, and increased consumer compliance.

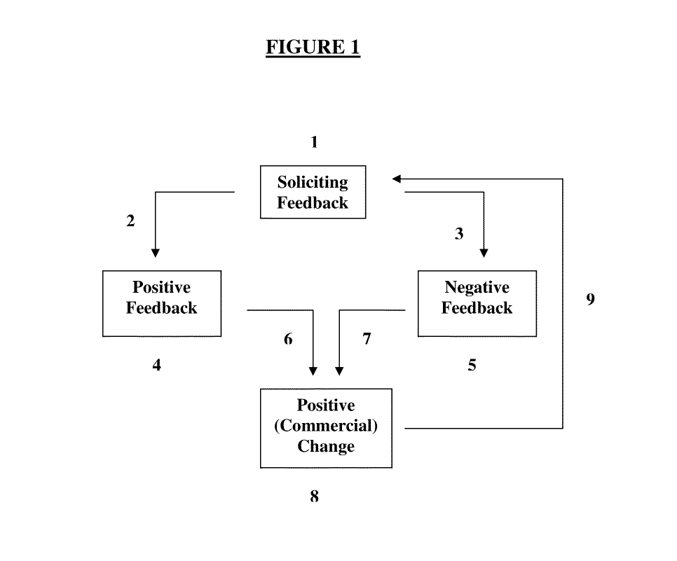

As shown in FIG. 1, generally, surveys are intended to solicit feedback 1 from consumers or potential consumers who have experienced or have a need for the goods or services of a business. The act of evaluating these goods and services through surveys administered in 2 and 3, may lead to positive feedback 4, negative feedback 5, or a combination of both. This feedback is analyzed in 6 and 7, and ultimately leads to positive (commercial) change 8. For example, analysis of negative feedback 5 may lead to avoiding actions taken during this negative experience, or positive feedback 4 may lead to performing actions taken during this positive experience.

Ultimately, the positive (commercial) change 8 is tested through an iterative process by again soliciting feedback in 1.

However, without sufficient consumer compliance the data obtained has very little statistical significance. In particular, FIG. 1 demonstrates that without data to support significant positive or negative feedback pathways, appropriate positive change cannot occur, or inappropriate, ill-characterized change could occur.

Improving the statistical significance of consumer feedback affords enhancement of the analysis of consumer feedback with a greater ability to determine the root cause of negative consumer feedback, and make well-informed proper decisions with respect to positive change, e.g., commercial or noncommercial.

Accordingly, the present invention provides reward systems, e.g., for use with surveys (e.g., Micro-Surveys) for use by entities desiring to analyze consumer sentiment, opinion, or feedback of consumers. These reward systems are designed to increase consumer compliance in events such as non-purchase events, for example, completing surveys.

As such, in one embodiment, Micro-Surveys are written in a root cause analysis format. In this respect, whereas other survey formats will ask for a consumer's general impression of every aspect of a product or experience, the format of the Micro-Surveys of the present invention ask questions that will follow a particular information stream, or unified question stream (UQS) to determine the root cause of a problem. If a consumer does not identify an aspect of their experience as having a problem, it can be concluded that the consumer was generally satisfied with that aspect. Certain embodiments of the method of identifying a root cause of negative consumer feedback comprise the step of offering a reward for answering all the questions of a survey, e.g., a Micro-Survey, wherein such reward would be selected and stored in the profile of the consumer. The reward may be the product or services of the user, or the product or services of another user, e.g., a sponsor of the website. In certain embodiments, the reward is selected from the group consisting of promotional items, coupons, rebates, discounts, or special offerings on goods and/or services.

In certain embodiments, the binary questions are answered by indicating a + symbol for a positive response or a − symbol for a negative response based on the consumer experience with the goods or services of the user.

In certain embodiments, the binary questions are answered by indicating a checkmark symbol for a positive response or an X symbol for a negative response based on the consumer experience with the goods or services of the user.

In another embodiment, the identification of the root cause of negative consumer feedback through the use of surveys, e.g., Micro-Surveys, in combination with the use of rewards systems of the present invention, comprises the use of statistical analysis of the total user data set based on the propensity of the consumer established in the consumer profiles. In one particular embodiment, more statistical significance is given to consumer profiles that do not provide negative feedback greater than 50% of the time. In another particular embodiment, less statistical significance is given to consumer profiles that provide negative feedback greater than 50% of the time. In yet a further particular embodiment, the statistical analysis is performed by using the following formula:

$${\sum }_{i = 0}^{r} {R}_{i} - {\sum }_{i = 0}^{n} {N}_{i}$$

wherein

for each consumer, a consumer recommendation factor (CRF) is calculated as the number of positive answers divided by the total number of Micro-Surveys completed;

for each consumer, a consumer negativity factor (CNF) is calculated using the equation: 1-CRF;

R is the set of CNFs of r users who submitted positive answers, and Rᵢ is the CNF of the i^{th} member in set R; and

N is the set of CRF's of n users who submitted negative answers, and Nᵢ is the CRF of the i^{th} member in set N. The result of the statistical analysis may be used as calculated or manipulated to provide a more consumer/user usable value, e.g., as a percentage.

Alternatively, in another embodiment of the invention the statistical analysis of the total user data set is based on consumer segment survey analysis, wherein users are compared to other businesses/users in their market, or consumer segment. In one particular embodiment, the consumer segment survey analysis is performed by using the following formula to establish the percentage, P, of stores that have a lower raw rating than the user:

P=100*(N₁/N_{Tot})

wherein

N₁ is number of raw ratings that are less than the raw rating of user;

N_{Tot} is the total number of raw ratings in the consumer segment; and

the raw rating of a user is determined by the number of positive ratings for a certain question for that user divided by the total number of ratings for the user. In certain embodiments, N_{Tot} is greater than or equal to 10.

In certain embodiments, the ability to identify the root cause of negative consumer feedback is enhanced through the use of the reward systems of the present invention. For example, the enhancement may be due to a factor selected from the group consisting of increased consumer participation, increased root cause analysis accuracy, increased statistical significance of root cause, and increased consumer compliance.

### V. EXEMPLIFICATION OF IMPLEMENTING SOFTWARE

The methods of the invention may be implemented in any manner that achieves the intended purpose of the methods. However, in one embodiment, the methods of the invention may be implemented using software applications (e.g., via mobile devices such as smartphones or tablets, or via a desktop application) or via the internet.

In one particular embodiment, the implementation of such software may be combined with the software related to a non-purchase event, e.g., administration of surveys, e.g., Micro-Surveys. For example, every completed event, such as a survey, earns a reward. For example, a selected gift card goes into the consumer's “wallet”, which can be accessed from a graphic user interface, e.g., a “My Wallet” tab. In particular embodiments, clicking on a gift card brings the consumer to the coupon screen.

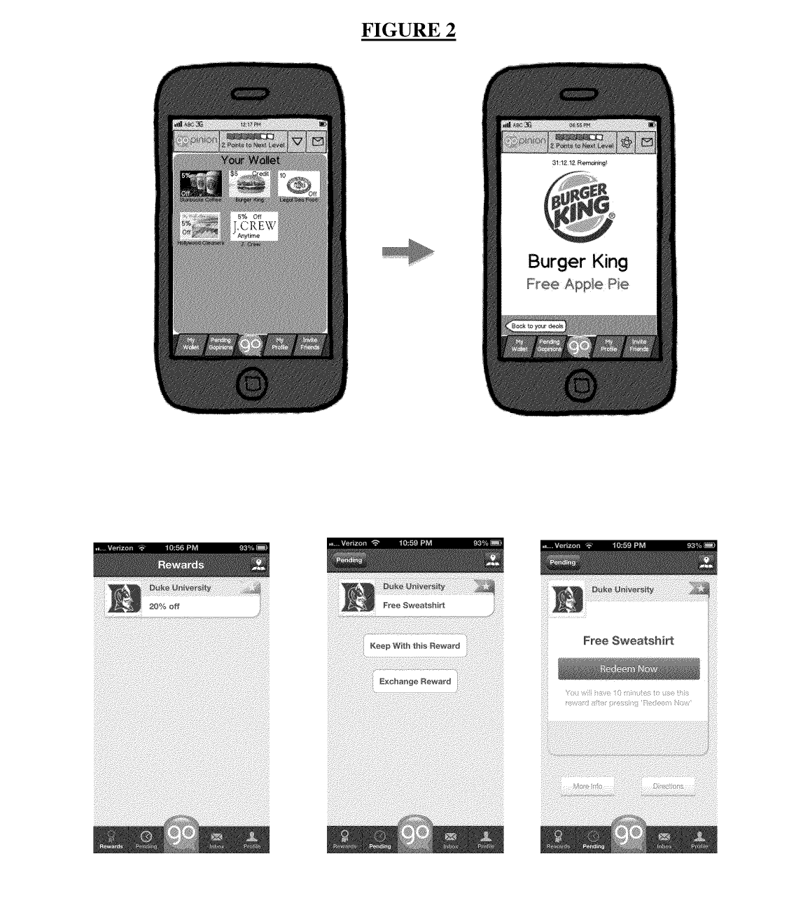

In certain embodiments, the coupon will display what it is good for, and a timer at the top. In a particular embodiment, after opening the coupon, the consumer will have a defined period of time, e.g., 1 hour, to use it before it disappears; wherein store employees would be instructed not to accept the coupon unless the timer at the top is moving. See, for example FIG. 2. In a specific embodiment, as soon as the coupon disappears, a notification will be sent to the merchant's/user's dashboard telling them what coupon was redeemed, and at what time it was redeemed.

In certain embodiments, the redeem page will have multiple sections, e.g., “Get a Deal Here” or “Get a Deal from Another Gopinion Venue”. The “Get a Deal Here” section may involve a deal that they could redeem either on the spot, or a deal (e.g., larger deal) that could be redeemed on a return visit. The “Get a Deal from Another Gopinion Venue” section may have one or more of the following so that consumer is able to find the exact deal they want: featured deals, nearby deals, and a search function. This search function may be combined with geo-fencing and/or interaction with a low energy Bluetooth device such as an iBeacon.

In one embodiment, a leveling scheme may be established based on the concept of greater levels of discount for consumers that use the application more. In certain embodiments, the reward may be based on how many times the consumer engages a user (e.g., how many surveys, e.g., Micro-Surveys, a consumer has completed), e.g., over a designated period of time (e.g., one Micro-Survey may be a tier I, two Micro-Surveys may be a tier II, or three Micro-Survey may be a tier III, etc., and a schedule of when these must occur may also affect the reward, such as over consecutive days). Alternatively, Table 1 shows a sample leveling scheme, wherein EPs represents Earned

Points.

TABLE 1

| | Accumulated | | | |
|---|---|---|---|---|
| Levels | EPs per Level | | Names of Levels | Range of Offers at Level |
| 1 | 0 to 9 | pts | New In Town | 2% to 5% discount |
| 2 | 10 to 49 | pts | Neighborhood Star | 4% to 7.5% |
| 3 | 50 to 99 | pts | Main Street Hero | 6% to 10% |
| 4 | 100 to 199 | pts | Local Legend | 8% to 12.5% |
| 5 | ≧200 | pts | City Champion | 10% to 15% |

Certain components/elements of such software are below and are structured for the consumer, while certain components/elements are structured for the user.

i. Consumer Specific Elements

Certain elements of the Application are structured for the consumer. In a mobile application there are a number of “buttons” that produce certain actions

### Consumer Facing Web App

The web app, with similar functionality to a mobile device based application, or app, does not require a consumer to have a smartphone. In certain embodiments, the consumer facing web app will be initiated by entering in an alphanumeric code to link to surveys, e.g., instead of scanning them at the location. In certain aspects of the Consumer Facing Web App one or more of the following may be utilized in the design of the web or mobile app:

A. Home Page

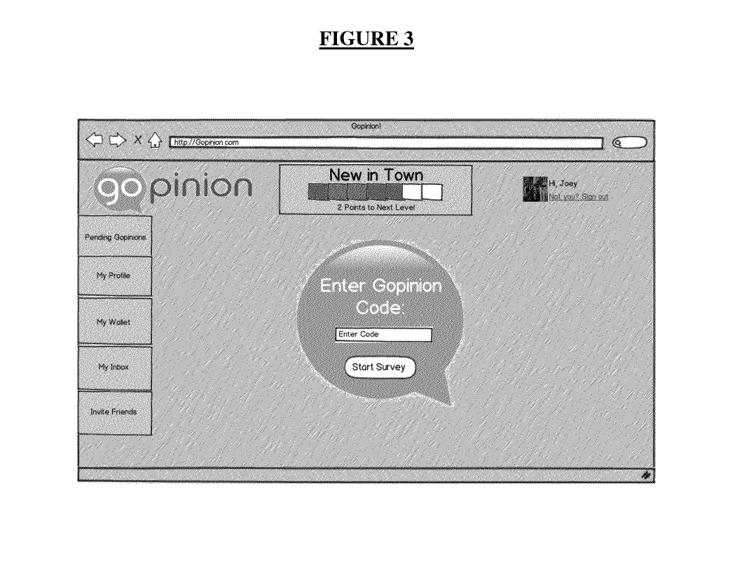

After logging in, the home page (see FIG. 3) for the user will be a very simple, code input field where the user can enter in an alphanumeric code that corresponds to a purchase they made. In particular embodiments, clicking the logo, e.g., in the top right, will bring the user back to this screen from anywhere in the user's section:

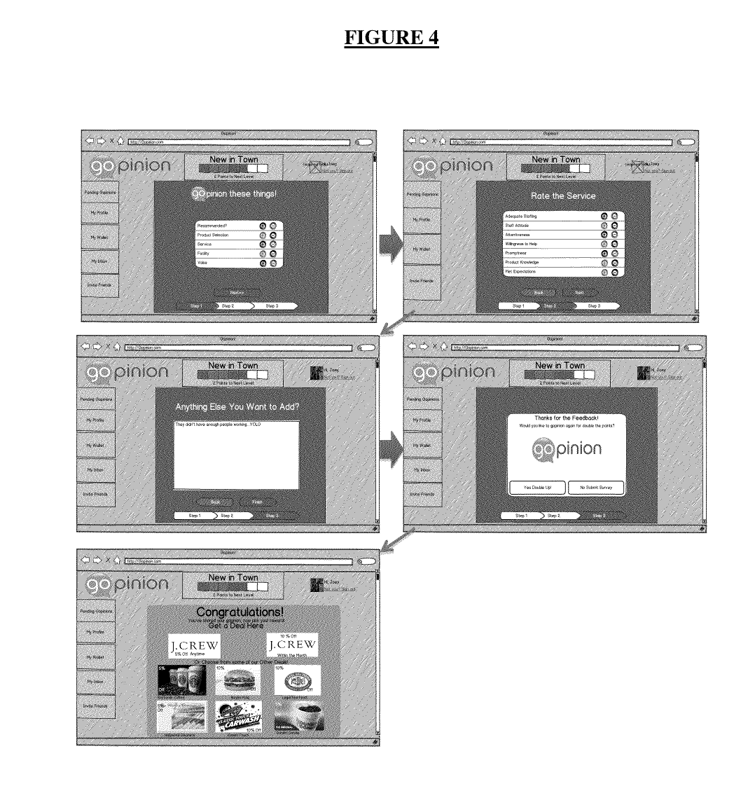

For example, if the transaction is a survey, the survey stream for the web app may be the same as in the mobile app question stream. And at the end it will take the user to a similar prize-redeem page, wherein this process flow is shown in FIG. 4. The sidebar buttons/tabs may also be similar to the mobile app.

B. Pending Gopinions

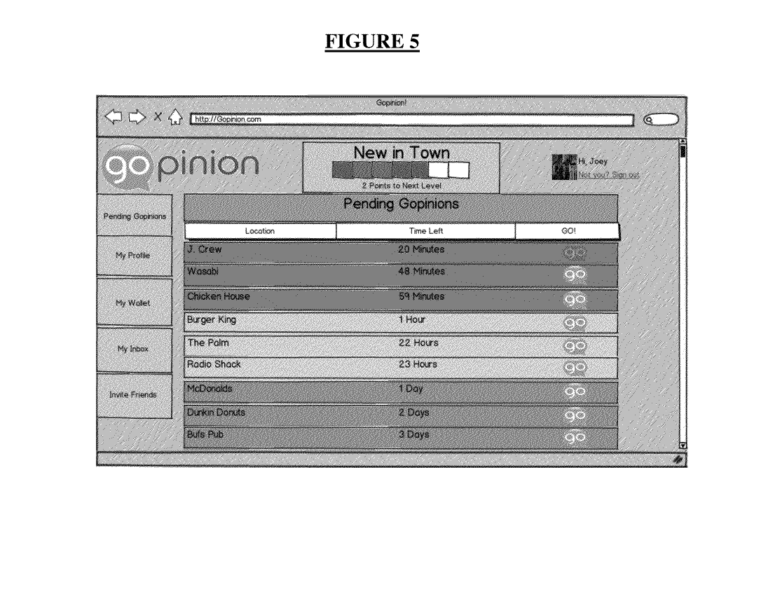

Just like in the mobile app, this page, e.g., shown in FIG. 5, may hold Micro-Surveys, or “Gopinions” that were begun, e.g., scanned, but not completed. They will stay in this section for a given period, e.g., 3 days, before disappearing:

C. My Wallet

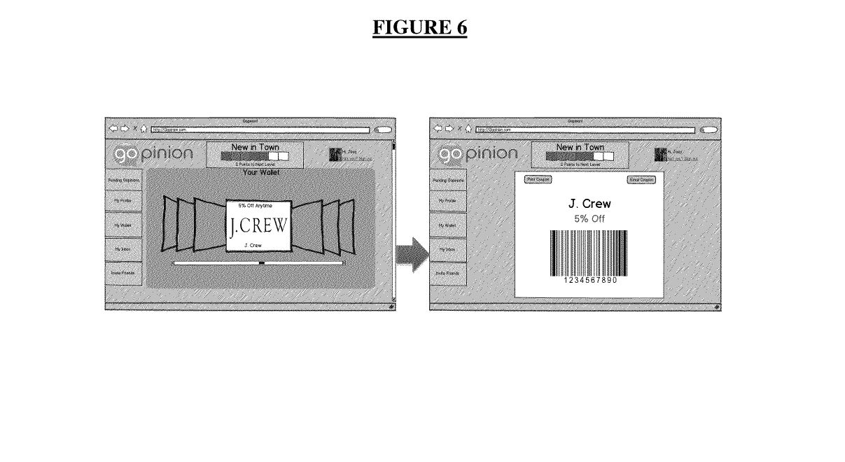

As can be seen in FIG. 6, the “My Wallet” section may allow the consumer to view and manage offers. From this page the consumer will be allowed to print coupons or send them to their email.

ii. User Specific Elements

Certain elements of the application are structured for the user. In one embodiment, the user facing app will only be a web app. In another embodiment, the user facing app is optimized for mobile/tablet browsing. In certain embodiments of the user facing app, the buttons and information are arranged in a “Dashboard.”

### User/Business Facing Web Application: Dashboard Elements

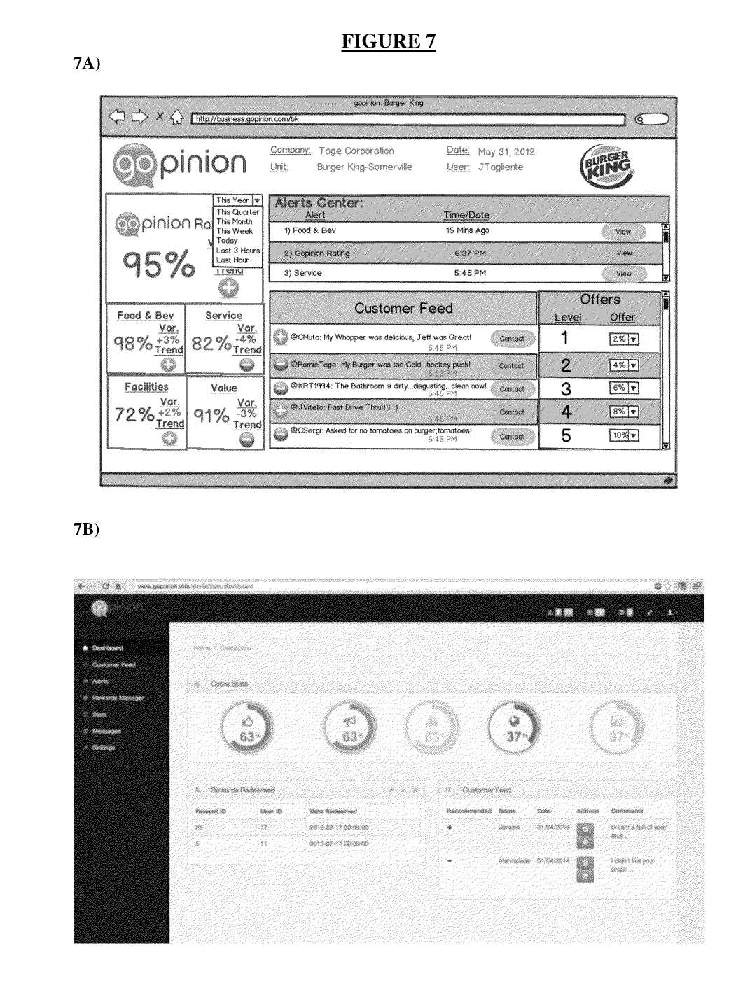

In one embodiment, the user is able to garner the most important bits of information about the way the business is currently running by a quick review of the Dashboard. In certain embodiments the Dashboard is live-updating. The components are shown in the FIGS. 7A and 7B.

In certain embodiments, the overall rating, or the gopinion rating, e.g., based on the data obtained from the Micro-Surveys completed by the consumers, is prominently displayed. These gopinion numbers may be set on a scale from 0-100 to give the gopinion score in a readable, at-a-glance number for the user.

Customer Feed

In certain embodiments, businesses/users will be able to manage the rewards they are willing to give (e.g., percentages etc.), and may also offer free things instead of percentage discounts (e.g., if a fast food restaurant wants to offer free apple pie now as a deal).

Offers Manager

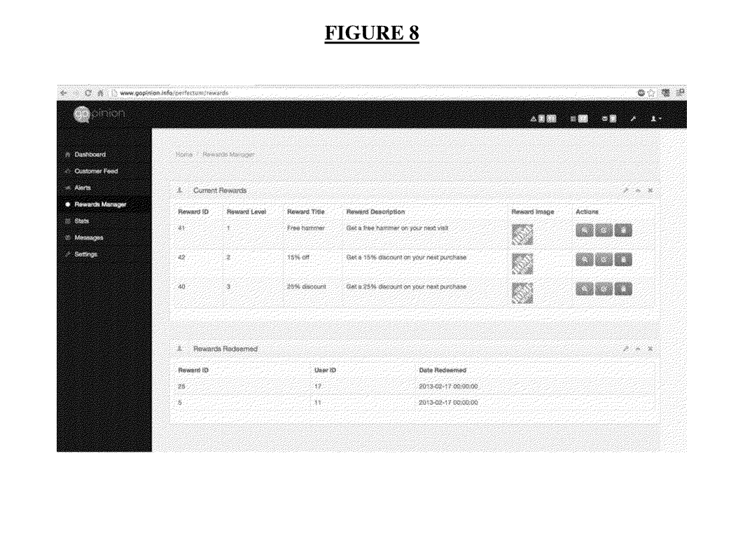

In certain embodiments, the “Office Manager” (see FIG. 8) is a box on the dashboard that allows the user to set their discount rates for each of the levels of user at their establishment, e.g., restaurant.

Individual Popcharts

In certain embodiments, each of the boxes on the left (gopinion rating, food & bev etc) is a clickable object that allows the user to delve deeper into the data. The individual ratings pages may show a graph of that company's performance against the market average (or another category of the user's choosing) in that category over the period of time that they select.

In certain embodiments, the user will be able to toggle back and forth between the overall rating and a more in-depth look at individual response rates within the category in question.

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Although the heretofore description discloses example methods, articles of manufacture, apparatus and/or systems including, among other components, software executed on hardware, it should be noted that such methods, articles of manufacture, apparatus and/or systems are merely illustrative and should not be considered as limiting. For example, it is contemplated that any or all of these hardware and software components could be embodied exclusively in hardware, exclusively in software, exclusively in firmware or in any combination of hardware, firmware and/or software.

Accordingly, while the following describes example methods, articles of manufacture, apparatus and/or systems, the examples provided are not the only way to implement such methods, articles of manufacture, apparatus and/or systems.

Such equivalents are considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A method of offering a plurality of rewards to a consumer comprising the steps of
initiation of an interface by a consumer of goods or services of a first user on a network;
completion of a transaction on the network by the consumer of the goods or services;
presentation on the network of a first user-affiliated reward to the consumer using a Multi-User Reward Integration (MURI) system, wherein the MURI system presents the first user-affiliated reward in combination with one or more secondary user-affiliated rewards from users that are not said first user,
such that a plurality of rewards is offered to the consumer.

2. The method of claim 1, wherein the method further comprises the step of administration of the user-affiliated reward to the consumer on the network.

3. The method of claim 2, wherein the method further comprises the step of storage of said user-affiliated reward on the network.

4. The method of any one of claims 1 to 3, wherein the method further comprises the step of establishment of a consumer profile on the network, wherein said user-affiliated reward is combined with other administered rewards, and stored.

5. The method of any one of claims 1 to 4, wherein interfacing by the consumer over a network is accomplished by using the internet over a mobile device.

6. The method of any one of claims 1 to 4, wherein interfacing by the consumer over a network is accomplished by using the internet over a computer.

7. The method of any one of claims 1 to 6, wherein the initiation of the interface by the consumer is accomplished by launching an application on a smartphone or tablet device.

8. The method of any one of claims 1 to 7, wherein the user-affiliated rewards are selected from the group consisting of promotional items, coupons, rebates, discounts, and special offerings on goods or services.

9. The method of any one of claims 1 to 8, wherein the transaction is a non-purchase event.

10. The method of claim 9, wherein the user-affiliated reward is a discount.

11. The method of claim 9, wherein the user-affiliated reward is a coupon.

12. The method of any one of claims 1 to 8, wherein the transaction is a purchase event.

13. The method of any one of claims 1 to 7, wherein the user-affiliated rewards are selected from the group consisting of promotional items, coupons, rebates, discounts, and special offerings on goods or services, with the proviso that the transaction is a purchase event when the user-affiliated reward is a promotional item or a special offering.

14. The method of any one of claims 1 to 13, wherein the first user-affiliated reward is not directed to a good or service similar to the secondary user-affiliated reward.

15. The method of claim 2, wherein the first user-affiliated reward is selected by the consumer and administered to the consumer.

16. The method of claim 2, wherein the secondary user-affiliated reward is selected by the consumer and administered to the consumer.

17. A Multi-User Reward Integration (MURI) system comprising a machine readable medium having instructions stored thereon for execution by a processor to perform a method of offering a plurality of rewards to a consumer comprising the steps of
initiation of an interface by a consumer of goods or services of a first user on a network;
completion of a transaction on the network by the consumer of the goods or services;
presentation on the network of a first user-affiliated reward to the consumer using a Multi-User Reward Integration (MURI) system, wherein the MURI system presents the first user-affiliated reward in combination with one or more secondary user-affiliated rewards from users that are not said first user, such that a plurality of rewards is offered to the consumer.

18. The Multi-User Reward Integration (MURI) system of claim 17, wherein the instructions stored on the machine-readable medium are mobile application software.

19. The Multi-User Reward Integration (MURI) system of claim 17, wherein the instructions stored on the machine-readable medium are online software.

20. The Multi-User Reward Integration (MURI) system of claim 19, wherein the software is an online application.

21. The Multi-User Reward Integration (MURI) system of claim 20, wherein the software is a web-based application.

22. The Multi-User Reward Integration (MURI) system of claim 20, wherein the software is a cloud-based application.

23. The Multi-User Reward Integration (MURI) system of any one of claims 17 to 22, wherein the machine-readable medium is selected from the group consisting of magnetic media, optical disks, and solid state devices.

24. The Multi-User Reward Integration (MURI) system of claim 17, wherein the method further comprises the step of administration of the user-affiliated reward to the consumer on the network.

25. The Multi-User Reward Integration (MURI) system of claim 24, wherein the method further comprises the step of storage of said user-affiliated reward on the network.

26. The Multi-User Reward Integration (MURI) system of any one of claims 17 to 25, wherein the method further comprises the step of establishment of a consumer profile on the network, wherein said user-affiliated reward is combined with other administered rewards, and stored.

27. The Multi-User Reward Integration (MURI) system of any one of claims 17 to 26, wherein interfacing by the consumer over a network is accomplished by using the internet over a mobile device.

28. The Multi-User Reward Integration (MURI) system of any one of claims 17 to 26, wherein interfacing by the consumer over a network is accomplished by using the internet over a computer.

29. The Multi-User Reward Integration (MURI) system of any one of claims 17 to 28, wherein the initiation of the interface by the consumer is accomplished by launching an application on a smartphone or tablet device.

30. The Multi-User Reward Integration (MURI) system of any one of claims 17 to 29, wherein the user-affiliated rewards are selected from the group consisting of promotional items, coupons, rebates, discounts, and special offerings on goods or services.

31. The Multi-User Reward Integration (MURI) system of any one of claims 17 to 30, wherein the transaction is a non-purchase event.

32. The Multi-User Reward Integration (MURI) system of claim 31, wherein the user-affiliated reward is a discount.

33. The Multi-User Reward Integration (MURI) system of claim 31, wherein the user-affiliated reward is a coupon.

34. The Multi-User Reward Integration (MURI) system of any one of claims 17 to 30, wherein the transaction is a purchase event.

35. The Multi-User Reward Integration (MURI) system of any one of claims 17 to 29, wherein the user-affiliated rewards are selected from the group consisting of promotional items, coupons, rebates, discounts, and special offerings on goods or services, with the proviso that the transaction is a purchase event when the user-affiliated reward is a promotional item or a special offering.

36. The Multi-User Reward Integration (MURI) system of any one of claims 17 to 35, wherein the first user-affiliated reward is not directed to a good or service similar to the secondary user-affiliated reward.

37. The Multi-User Reward Integration (MURI) system of claim 24, wherein the first user-affiliated reward is selected by the consumer and administered to the consumer.

38. The Multi-User Reward Integration (MURI) system of claim 24, wherein the secondary user-affiliated reward is selected by the consumer and administered to the consumer.

39. A method of advertising goods or services by offering a consumer a user-affiliated reward comprising the steps of
initiation of an interface by a consumer of goods or services of a first user on a network;
completion of a transaction on the network by the consumer of the goods or services;
presentation on the network of a first user-affiliated reward to the consumer using a Multi-User Reward Integration (MURI) system, wherein the MURI system presents the first user-affiliated reward in combination with one or more secondary user-affiliated rewards from users that are not said first user,
such that the presentation of the first user-affiliated reward or the secondary user-affiliated rewards serves to advertise the presented rewards offered to the consumer.

40. The method of claim 39 further comprising the step of administration of the user-affiliated reward to the consumer on the network.

41. The method of claim 40 further comprising the step of storage of said user-affiliated reward on the network.

42. The method of any one of claims 39 to 41 further comprising the step of establishment of a consumer profile on the network, wherein said user-affiliated reward is combined with other administered rewards, and stored.

43. The method of any one of claims 39 to 42, wherein interfacing by the consumer over a network is accomplished by using the internet over a mobile device.

44. The method of any one of claims 39 to 42, wherein interfacing by the consumer over a network is accomplished by using the internet over a computer.

45. The method of any one of claims 39 to 44, wherein the initiation of the interface by the consumer is accomplished by launching an application on a smartphone or tablet device.

46. The method of any one of claims 39 to 45, wherein the user-affiliated rewards are selected from the group consisting of promotional items, coupons, rebates, discounts, and special offerings on goods or services.

47. The method of any one of claims 39 to 46, wherein the transaction is a non-purchase event.

48. The method of claim 47, wherein the user-affiliated reward is a discount.

49. The method of claim 47, wherein the user-affiliated reward is a coupon.

50. The method of any one of claims 39 to 46, wherein the transaction is a purchase event.

51. The method of any one of claims 39 to 45, wherein the user-affiliated rewards are selected from the group consisting of promotional items, coupons, rebates, discounts, and special offerings on goods or services, with the proviso that the transaction is a purchase event when the user-affiliated reward is a promotional item or a special offering.

52. The method of any one of claims 39 to 51, wherein the first user-affiliated reward is not directed to a good or service similar to the secondary user-affiliated reward.

53. The method of claim 40, wherein the first user-affiliated reward is selected by the consumer and administered to the consumer.

54. The method of claim 40, wherein the secondary user-affiliated reward is selected by the consumer and administered to the consumer.

55. A method of offering a plurality of rewards to a consumer engaged in a non-purchase event comprising the steps of
initiation of an interface by a consumer of goods or services of a first user on a network;
completion of a non-purchase event on the network by the consumer of the goods or services;
presentation on the network of a first user-affiliated reward to the consumer using a Multi-User Reward Integration (MURI) system, wherein the MURI system presents the first user-affiliated reward in combination with one or more secondary user-affiliated rewards from users that are not said first user,
such that a plurality of rewards is offered to the consumer.

56. The method of claim 55 further comprising the step of administration of the user-affiliated reward to the consumer on the network.

57. The method of claim 56 further comprising the step of storage of said user-affiliated reward on the network.

58. The method of any one of claims 1 to 57 further comprising the step of establishment of a consumer profile on the network, wherein said user-affiliated reward is combined with other administered rewards, and stored.

59. The method of any one of claims 1 to 58, wherein interfacing by the consumer over a network is accomplished by using the internet over a mobile device.

60. The method of any one of claims 1 to 58, wherein interfacing by the consumer over a network is accomplished by using the internet over a computer.

61. The method of any one of claims 1 to 60, wherein the initiation of the interface by the consumer is accomplished by launching an application on a smartphone or tablet device.
